(19) United States
(12) Patent Application Publication
(10) Pub. No.: US 2019/0157807 A1
(43) Pub. Date: May 23, 2019

(54) Electromagnetic Connection Assembly

(71) Applicant: AAC Technologies Pte. Ltd., Singapore city (SG)

(72) Inventors: Daniel Jansson, Shenzhen (CN); Shaohai Chen, Saratoga, CA (US)

(21) Appl. No.: 15/971,051

(22) Filed: May 4, 2018

(30) Foreign Application Priority Data
Nov. 21, 2017 (CN) 201711162124.X

(51) Int. Cl. H01R 13/648; H01R 13/03; H01Q 1/22; G06F 3/043

(52) U.S. Cl. CPC H01R 13/648; G06F 3/043; H01Q 1/22; H01R 13/03

(57) ABSTRACT

An electromagnetic connection assembly includes a first connector and a second connector. The first connector includes a first housing, a first conductive part and a first magnetic absorption part, the second connector includes a second housing, a second conductive part and a second magnetic absorption part. The first magnetic absorption part and the second magnetic absorption part are magnetically adsorbed to achieve the conducting connection between the first connector and the second connector. Compared with related technology, the electromagnetic connection assembly provided by the invention achieves low contact force, high reliability, small volume, low cost, flexible design and zero contact indentation, without any impact to its appearance.

### FIELD OF THE PRESENT DISCLOSURE

The invention relates to the field of a connector and its combination, in particular to an electromagnetic connection assembly of an electronic device.

### DESCRIPTION OF RELATED ART

With the rapid development of semiconductor technology and integrated circuits, the demand for high-frequency signals, low-frequency signals and power signals between assemblies in integrated circuits is becoming more and more diverse. In order to adapt the variety of connectors, the electromagnetic connection part is used to complete the circuit or connect two or more circuits together. Connections between paired metal assemblies must provide good electrical conductivity to complete the circuit.

In the related technology, the electromagnetic connection assembly mostly adopts the detachable design, including a connection head and a connection seat, which usually has a magnet and a low voltage spring in the connection seat to achieve the connection between the connection head and the connection seat. This type of connection makes the connector unnecessarily large and heavy, and does not apply to small, precision integrated circuits or FPCB connections.

Therefore, it is necessary to provide new electromagnetic connection assembly to overcome the above shortcomings.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a schematic diagram of a first embodiment of an electromagnetic connection assembly of the present invention;

FIG. 2 is a structure diagram of the electromagnetic connection assembly shown in FIG. 1;

FIG. 3 is a first magnetic part structure diagram of the electromagnetic connection assembly of the invention;

FIG. 4 is a second magnetic part structure diagram of the electromagnetic connection assembly of the invention;

FIG. 5 is a structure diagram of a second embodiment of the electromagnetic connection assembly of the present invention;

FIG. 6 is a schematic diagram of the first connection mode of the electromagnetic connection assembly of the present invention;

FIG. 7 is a schematic diagram of a second connection mode of the electromagnetic connection assembly of the present invention;

FIG. 8 is a schematic diagram of a third connection mode of the electromagnetic connection assembly of the present invention.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

A clear and complete description of the technical scheme in the embodiment of the present invention will be made below, and it is clear that the embodiment is only a part of the embodiment of the invention and not all embodiments. Based on the embodiment of the invention, all other embodiments obtained by ordinary technicians in the art without making creative labor belong to the scope of protection of the present invention.

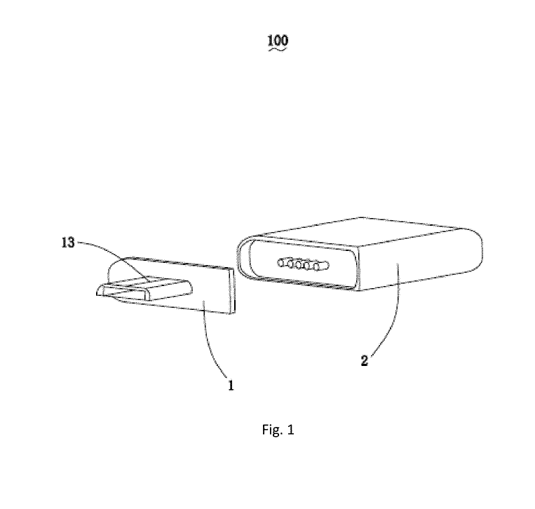

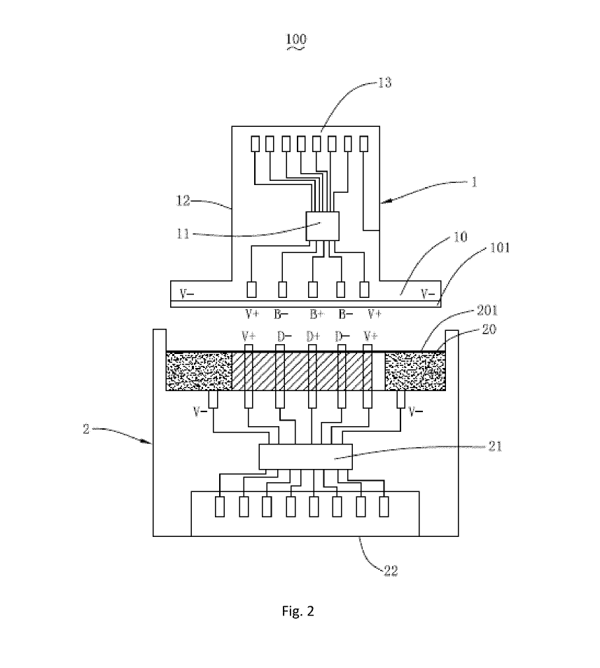

Refer to both FIGS. 1 and 2, the electromagnetic connection assembly 100 comprises a first connector 1 and a second connector 2, and the first connector 1 and the second connector 2 are capable of docking by magnetic absorption.

The first connector 1 comprises a first magnetic absorption part 10, a first conductive part 11 and a first housing 12. The first housing 12 has the first magnetic absorption part 10 accommodated in the accommodation space, and the first conductive part 11 is mounted in the first housing 12, and the first conductive part 11 is connected with the first magnetic absorption part 10, and the first magnetic absorption part 10 comprises a first magnetic part 101 arranged at the end part thereof for connecting with the second connector 2 by magnetic adsorption.

The second connector 2 comprises a second magnetic absorption part 20, a second conductive part 21 and a second housing 22 capable of interacting with the first magnetic absorption part 10, and the second housing 22 has a second magnetic absorption part 20 accommodated by accommodation space, and the second conductive part 21 is mounted in the second housing 22, and the second conductive part 21 is connected to the second magnetic absorption part 20, and the second magnetic absorption part 20 comprises a second magnetic part 201 for connecting with the first magnetic absorption part 10 of the first connector 1 in adsorbed manner, in order to connect the first connector 1 to the second connector 2.

The first connector 1 is a male head, the second connector 2 is a female head, and the first connector 1 comprises a plug part 13, and the electromagnetic connection assembly 100 is plugged into an interface of an electronic device through the plug part 13 for charging and/or data transmission, such as a mobile phone, a tablet etc. The plug part 13 is anyone of the USB2.0 connector, Lighting Dock connector, USB type-C connector, or micro connector.

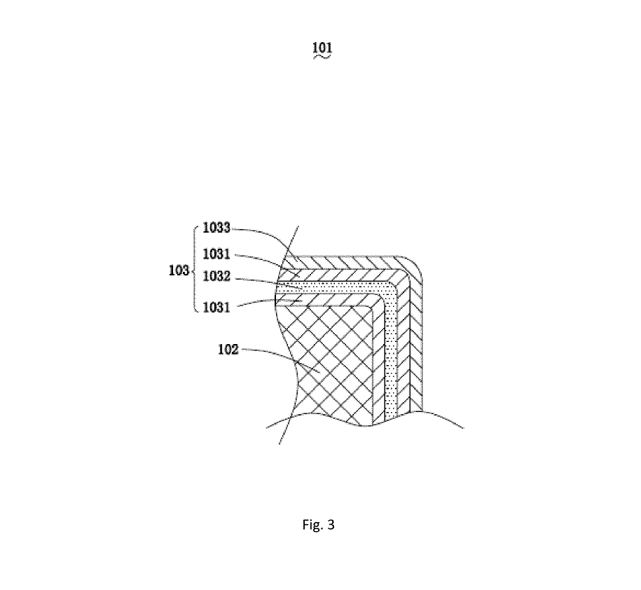

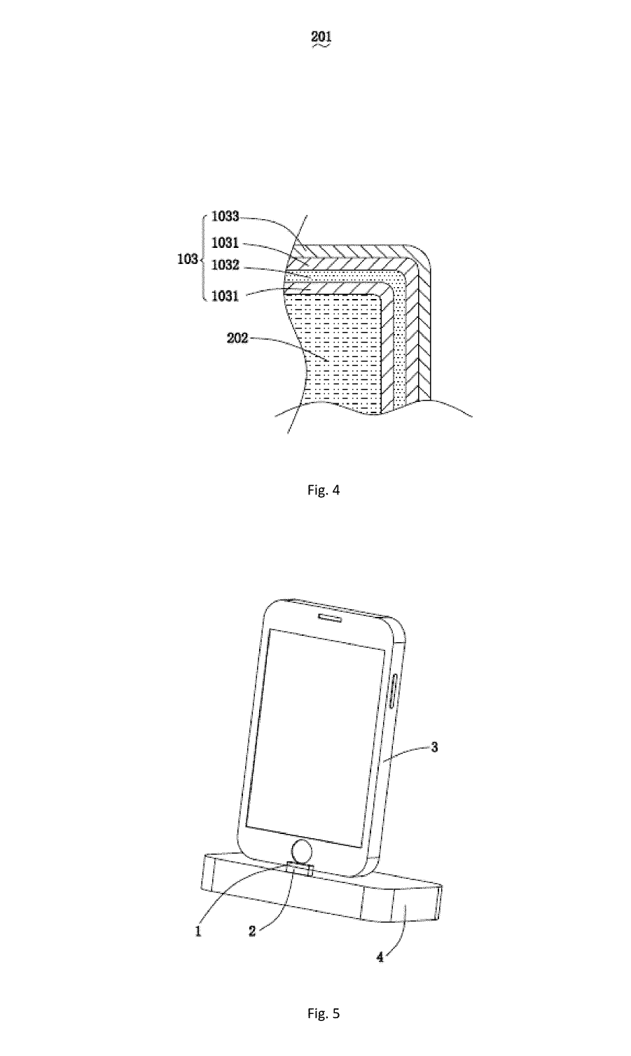

Refer to both FIGS. 3 and 4, the first magnetic part 101 comprises a magnetic substrate 102 and a metal conductive coating 103 arranged on the surface of the magnetic substrate, and the magnetic substrate 102 is made of a neodymium magnet, and the second magnetic part 201 comprises an iron base material substrate 202 and a metal conductive coating 103 arranged on the surface of the iron base material substrate, and the metal conductive coating 103 is coated on the surface of the magnetic substrate 102 and/or the iron base material substrate 202 by an electroplating or physical vapor deposition process, and the magnetic material of the first magnetic part 101 and the second magnetic part 201 is interchangeable and identical substantially.

The metal conductive coating 103 is made of a low impedance high conductivity metal material and comprises at least two of a nickel layer 1031 a copper layer 1032 and a gold layer 1033. The structure of the metal conductive coating 103 is anyone from a nickel layer-a copper layer-a nickel layer-a gold layer, a nickel layer-a copper layer-a nickel layer, or a nickel layer-a copper layer-a gold layer from inside to outside.

The nickel layer-copper layer-nickel layer-gold layer is a nickel layer 1031 coated on the surface of the magnetic substrate 102 and a copper layer 1032 coated on the nickel layer 1031, a nickel layer 1031 coated on the copper layer 1032 and a gold layer 1033 coated on the nickel layer 1031.

The nickel layer-copper layer-nickel layer is a nickel layer 1031 coated on the surface of the magnetic substrate 102, a copper layer 1032 coated on the nickel layer 1031 and a nickel layer 1031 coated on the copper layer 1032.

The nickel layer-copper layer-gold layer is a nickel layer 1031 coated on the surface of the magnetic substrate 102, a copper layer 1032 coated on the nickel layer 1031, and a gold layer 1033 coated on the copper layer 1032.

The layer thicknesses of the metal conductive coating 103 are as follows: the thickness of the copper layer 1032 is 12 μm, the thickness of the nickel layer 1031 is 0.3 μm and the thickness of the gold layer 1033 is 0.1 μm, and their layer thicknesses can be adjusted according to the reliability and stability of the connection.

Refer to FIG. 5, the first connector 1 is an interface of the electronic device 3, and the second connector 2 is arranged at the electrical connection end of the external circuit 4, which is connected to the electronic device 3 and the external circuit by connecting the second connector 2 with the first connector 1. The first connector 1 is connected with an acoustic element and/or a touch control part and/or an antenna assembly and/or an imaging part within the electronic device 3, and the second connector 2 is connected to an external circuit 4. The connection between the electronic element and the external circuit 4 is achieved by the conduction of the first connector 1 and the second connector 2.

In particular, the electromagnetic connection part 100 may be used to connect two circuits or the connection circuit and the MEMS microphone, or the connection between the circuit and the speaker, and the FPC connecting speaker is mounted to one end of the magnet or connection between the circuit and the radiation antenna, or connection between circuit and technical actuator, or connection between circuit and camera module, etc.

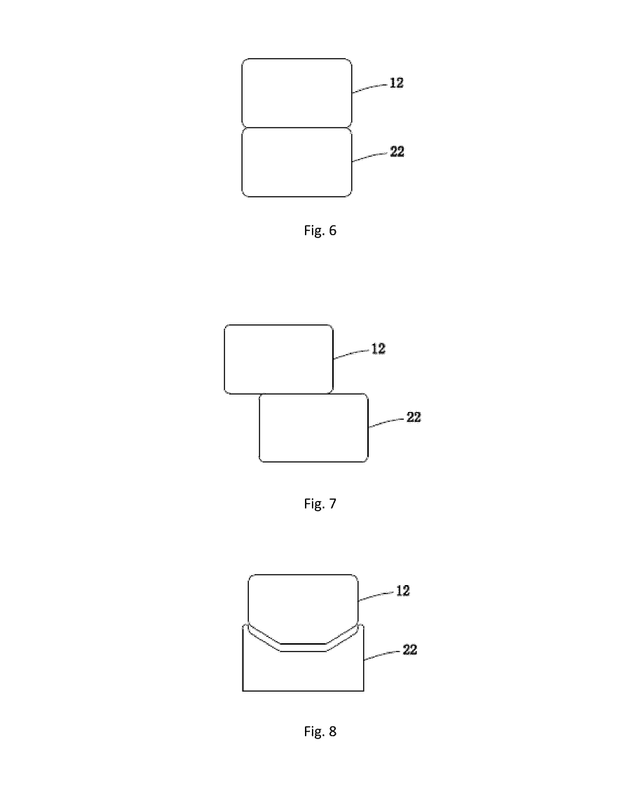

Refer also to FIGS. 6, 7, 8, the ports of the first housing 12 matched with the second housing 22 are consistent with the shape of the second housing 22, which may be made of cylinder or other geometrical shapes that can be cooperated and aligned as shown in fig.6, and the first housing 12 may be completely aligned with the second housing 22 or may be partially aligned as shown in FIG. 7, or the first housing 12 and the second housing 22 are designed to be embedded mutually as shown in FIG. 8, in order to ensure that the first connector 1 and the second connector 2 can always maintain an adaptive perfect alignment to enhance the reliability and self-guiding function of the electromagnetic connection assembly 100 connection.

The electromagnetic connection assembly of the invention comprises a magnetic substrate and a metal conductive coating arranged on the surface of the magnetic substrate through a built-in magnetic part. Thus, the electromagnetic connection assembly provided by the invention achieves low contact force, high reliability, small volume, low cost, flexible design and zero contact indentation, without any impact to its appearance.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An electromagnetic connection assembly, including:
a first connector including a first housing, a first conductive part, and a first magnetic absorption part accommodated in the first housing and connected with the first conductive part;
a second connector including a second housing, a second conductive part, and a second magnetic absorption part accommodated in the second housing and connected with the second conductive part;
the first magnetic absorption part and the second magnetic absorption part being magnetically adsorbed for connecting the first connector and the second connector; wherein
the first magnetic absorption part comprises a first magnetic part, and the second magnetic absorption part comprises a second magnetic part, and the first magnetic part and/or the second magnetic part has a metal conductive coating.

2. The electromagnetic connection assembly as described in claim 1, wherein the metal conductive coating comprises a gold-plated layer.

3. The electromagnetic connection assembly as described in claim 1, wherein at least one of the first magnetic part and the second magnetic part is a neodymium magnet, the metal conductive coating comprises at least two layers from a nickel layer, a copper layer and a gold layer.

4. The electromagnetic connection assembly as described in claim 3, wherein the metal conductive coating is selected from a nickel layer-a copper layer-a nickel layer-a gold layer, a nickel layer-a copper layer-a nickel layer, or a nickel layer-a copper layer-a gold layer.

5. The electromagnetic connection assembly as described in claim 4, wherein the thickness of the copper layer is 12 μm, the thickness of the nickel layer is 0.3 μm, and the thickness of the gold layer is 0.1 μm.

6. The electromagnetic connection assembly as described in claim 1, wherein the metal conductive coating is coated on the surface of the first magnetic part and/or the second magnetic part by an electroplating process or a physical vapor deposition process.

7. The electromagnetic connection assembly as described in claim 1, wherein one of the first magnetic part and the second magnetic part is a neodymium magnet, the other comprises an iron base material substrate and the metal conductive coating is arranged on the iron base material substrate surface.

8. The electromagnetic connection assembly as described in claim 7, wherein the first connector is a male head, the second connector is a female head, and the first connector comprises a plug part, and the electromagnetic connection assembly is plugged into an interface of the electronic device through the plug part for charging and/or data transmission, and the plug part is one of the USB2.0 connector, Lighting Dock connector, USB type-C connector, or micro connector.

9. The electromagnetic connection assembly as described in claim 7, wherein the first connector is an interface of an electronic device, and the second connector achieves the conduction with the electronic device by conducting with the first connector.

10. The electromagnetic connection assembly as described in claim 7, wherein the first connector is connected with an acoustic element and/or a touch assembly and/or an antenna assembly and/or an imaging part, and the second connector is connected with an external circuit, and the electronic element is connected with the external circuit through the conduction of the first connector and the second connector.

11. The electromagnetic connection assembly as described in claim 1, wherein the port of the first housing and the second housing are in accordance with the shape of the second housing; or the first housing and the descried second housing are embedded mutually.
